(19) United States
(12) Patent Application Publication
(10) Pub. No.: US 2026/0236729 A1
(43) Pub. Date: Aug. 13, 2026

(54) METHOD AND DEVICE FOR GENERATING THE BEHAVIOR OF AN ARTIFICIAL OPERATOR INTERACTING WITH A COMPLEX SYSTEM

(71) Applicant: THALES, MEUDON (FR)

(72) Inventor: Jean-Yves DONNART, MERIGNAC (FR)

(21) Appl. No.: 18/293,700

(22) PCT Filed: Jul. 22, 2022
(86) PCT No.: PCT/EP2022/070685

§ 371 Date: Jan. 30, 2024

(30) Foreign Application Priority Data
Jul. 30, 2021 (FR) 2108344

(51) Int. Cl. G06N 3/006

(52) U.S. Cl. CPC G06N 3/006

(57) ABSTRACT

A device and a computer-implemented method for generating a behavior of an artificial operator interacting with a complex system during a mission are provided. The mission being a real or simulated mission. Furthermore, a method for building human behavior models is provided.

### CROSS-REFERENCE TO RELATED APPLICATIONS

This application is a National Stage of International patent application PCT/EP2022/070685, filed on Jul. 22, 2022, which claims priority to foreign French patent application No. FR2108344, filed on Jul. 30, 2021, the disclosures of which are incorporated by reference in their entireties.

### FIELD OF THE INVENTION

The invention relates to the general field of artificial behavior, and the field of application is that of methods and devices for generating the behavior of an artificial operator interacting with a complex system.

### BACKGROUND

The invention is on the borderline between two technical fields:
that of modeling behavior, which allows participants in a constructive simulation or non-playing characters in a video game to be animated, by providing them with programmable behaviors; and
that of analyzing human behavior, which is also often referred to as “analyzing human factors”, which allows the actions of an individual to be analyzed using cognitive models in order to be able to explain their actions.

The technical field addressed by the invention is that which is defined as being that of “modeling human behavior”, inherited from Artificial Intelligence (AI), which attempts to reproduce a representative or realistic behavior of individuals.

The aim of the invention is to use this ability to model human behavior in order to generate the behavior of an artificial operator, in a simulation or when interacting with a real and complex system (for example, a pilot in an airplane, an air traffic controller, an operator in a nuclear power plant, etc.), by reproducing both the procedural aspects of the behavior of a human operator and the cognitive aspects of this behavior.

The technical problem addressed by the present invention is that of how to build a device (and an associated method) that allows the behavior of an artificial operator interacting with a complex system (for example, an artificial pilot in their airplane) to be generated based on gathering behavior data of one or more real operators on the same type of systems, and based on models that are deduced from analyzing all this data (for example, the invention allows the behavior of an artificial pilot to be generated using models created based on data gathered during real or simulated flights).

Many artificial intelligence techniques exist that allow the behavior of an artificial agent to be generated in a simulation. Most of these techniques rely on the use of formal techniques (behavioral trees, state graphs, rule-based systems, etc.) that allow the behavior of a real person to be reproduced in a simple but limited manner, as well as their interactions with the systems or participants present in the environment that is simulated.

This type of behavior generation is notably found in video games or in some civil or military simulations. These two categories of applications involve reproducing a scene of the game, or an operational situation, by generating the behavior that the participants are supposed to adopt in this scene or in this situation based on a given scenario. The role of the modeler then involves coding the sequences of actions of each of the participants without being able to specify the reasons behind these participants making this type of decision in real life.

The generated behavior is then qualified as being staged (or scripted), insofar as it only allows sequences of actions and interactions that are predetermined by an expert (for example, a “game designer” for a video game) to be reproduced. The corresponding artificial intelligence algorithms are perfectly adapted for generating the behavior of a set of artificial participants interacting with each other as in a film, but they have more difficulty generating realistic behaviors when this involves interacting with participants of the simulation that are controlled by real individuals.

In the latter case, the actions of the artificial agents are often qualified by an external observer as being:
“stupid”, since the generated behavior does not take into account the general context seen by the observer or is not consistent over the duration;
“robotic”, since the generated behavior applies predetermined procedures just as a robot would and not a behavior adapted to the situation as a human being would, which the artificial agent controlled by the Al is expected to represent.

The simplest and most used solution for addressing these two criticisms is to limit the number and the nature of the interactions to those that have been explicitly coded by the expert. This solution is obviously very limiting in terms of behavioral simulation and cannot be applied to the generation of the behavior of an artificial operator for a complex system, due to the number of situations that such a system can generate.

A better solution for addressing the first criticism (stupid behavior), and for obtaining a more consistent behavior, is machine learning. This involves learning generic reactions to all the situations that the artificial operator will potentially encounter.

This learning is possible because all the information required to build the behavioral rules is completely observable (conditions for activating the rules and actions carried out in the environment) or can be deduced from the observation (stored data, intermediate states between two transitions, etc.).

The role of the expert then occurs upstream, for example, for:
structuring the organization of the behaviors (for example: genetic fuzzy logic tree learning);
simplifying the input data (for example: behavioral tree learning);
defining the tests to be recorded (for example: case learning).

Moreover, these learned behaviors, as optimized as they can be, do not address the second criticism (robotic behavior) because the learned behaviors are only procedural. This type of model is best suited for generating an optimized but stereotyped behavior, but it does not allow the behavior of a human to be generated, with humans naturally using internal parameters in their decision-making processes that are not directly observable from outside.

In order to address the second criticism, academic models exist that are inspired by psychology or life sciences and that take into account cognitive aspects when modeling behavior (for example: the BDI (Believe, Desire, Intent) model by Michael Bratman, the emotions model by Nico Frijda, the motivations model by David McFarland, etc.). These purely formal models can be used to generate a behavior which, by means of the aspects, can appear to be human, but struggle to represent a more complex behavior than simple reactions to external stimuli, even if to this end they model an internal state of the simulated participant.

Once again, machine learning of cognitive models could address this requirement, but the only close work in this field relates to recognizing human behavior, where psychological or psychophysiological models (such as vigilance models, mental load management models, etc.) are learned from data gathered from individuals (for example, a pilot in an airplane or in a car, an air traffic control operator or a nuclear power plant operator, etc.), but only to evaluate the cognitive state of the operator.

Indeed, with further reference to the example of an airplane pilot, the problem is that the behavior of different pilots differs greatly. When confronted with a scenario at any identical point, each individual does not follow the flight procedures to the letter, as would be the case for a robot, but adopts a different behavior depending on their experience, their cognitive state and, more generally, how they evaluate the current situation.

Thus, the existing solutions are not capable of generating the behavior of an artificial operator interacting with a complex system that represents the behavior of a real operator, including, for example, that of an individual acting in a universe as restricted as that of a pilot in their cockpit, since the models that are used are not advanced enough:
a sufficiently realistic representation of the cognitive state of the simulated participants is missing in the behavior models used in the constructive simulations or the video games, which representation would allow a more human behavior to be generated that therefore would be closer to the observed behavior of a pilot; and
the cognitive models that are used to evaluate the behavior of an operator interacting with a complex system, such as, for example, a pilot in their aircraft, are a good avenue for simulating the cognitive state of an artificial operator, but they are not sufficient to be able to simulate their behavior as a whole.

Thus, no known solution proposes a device for generating the complete behavior of an artificial operator interacting with a complex system, i.e., including both the procedural and cognitive aspects of this behavior based on data originating from real operators.

Patent application US 2003/0167454 A1 by Iordanov et al. proposes a solution for simulating human behavior based on metacognitive processes. The human behavior model is built using expert data in declarative form (for the upper part of the breakdown of the mission) and machine learning (for the lower part of the behavior). However, the proposed cognitive architecture uses only symbolic mechanisms. It is a purely symbolic approach according to the definition provided in the article entitled “A Survey of Cognitive Architectures in the Past 20 Years” (Peijun Ye et al., IEEE TRANSACTIONS ON CYBERNETICS, IEEE, PISCATAWAY, NJ, USA, volume 48, number 12), including for learning mechanisms. Furthermore, no information gathered from real operators can be used to build a human behavior model or to validate the operation thereof, it only involves formal models that are purely theoretical and focused on performance.

A known solution does not exist that uses machine learning to model the behavior of this type of operator by taking into account both the procedural and cognitive aspects of this behavior.

### SUMMARY OF THE INVENTION

An aim of the invention is to address the aforementioned requirements and to overcome the disadvantages of the existing solutions and techniques.

The general principle of the invention involves implementing a “behavior generation engine” in a device for generating the behavior of an artificial operator, which engine instantiates a model that is defined by the inventors as a “human behavior model of the operator”, in order to generate the behavior of an artificial operator interacting with a given complex system.

The proposed device and the human behavior model rely on an operator behavior knowledge database (BCCO), which has been compiled prior to the execution of the method, and which contains a set of synchronized data gathered during interactions of one or more operators with the complex system.

Several artificial intelligence modules, combining both machine learning algorithms and formal methods using trade expertise, allow a human behavior model of the operator, i.e., a model capable not only of reproducing the procedural behavior of the operator but also of taking into account the human factors that can be involved in their decision-making, to be built in an iterative manner.

A first distinctive feature of the device of the invention compared to the prior art relates to taking into account two categories of factors in the engine for generating behavior that influence human decision-making, namely, the procedural aspects (follow a plan, comply with the rules, etc.) and the cognitive aspects (stress, mental load, fatigue, etc.).

A second distinctive feature of the device of the invention is to be able to generate behaviors that truly represent the interactions of actual operators with the considered complex system. In this way, the generated behavior can be used both in a simulation containing a realistic representation of this complex system, and also to build an artificial operator capable of controlling the actual complex system.

With further reference to the example of the airplane pilot, both the flight rules and procedures will have to be used, as well as the data gathered from a set of airplane pilots (on a simulator or during actual operation), in order to build a human behavior model of these aircraft pilots, and to use this model to generate the behavior of an artificial pilot in a simulator, then at the controls of the real airplane.

The proposed device allows the behavior of an artificial operator interacting with a complex system (for example, that of an aircraft pilot) to be generated, not only based on the existing procedure regulations, but also on a set of data recorded when one or more real operators interacts with this complex system or with complex systems of the same type.

Thus, instead of only representing the procedural aspects of the work of the operator, which inevitably leads to the generated behavior having a robotic, and therefore not very realistic, aspect, the proposed device is capable of integrating cognitive aspects such as fatigue, stress or mental load in this generation of behavior, which will allow more human aspects of the behavior of this type of operator to be represented and, in particular, the automatic management of situations not explicitly anticipated in the procedural rules.

The fields of operation of the invention are the fields of activity in which a complex system is controlled and implemented by one or more artificial operators. These trade fields include, for example, aeronautical, railway, or road transport, the fields of security, the fields of process control, energy, etc.

In order to obtain the desired results, the independent claim proposes a method for generating the behavior of an artificial operator interacting with a complex system during a mission, with the method being computer-implemented.

The human behavior model instantiated for the artificial operator has been learned in a learning phase, by applying artificial intelligence techniques to cognitive models and to procedural models using, over numerous simulations, a plurality of learning data for different operators, with the learning data being capitalized in a knowledge database of the behavior of operators of complex systems.

In one embodiment, the step of updating the cognitive state of the artificial operator takes into account the current situation that includes data concerning the situation perceived by the artificial operator and mission and environment context data.

In one embodiment, the human behavior model is represented as a hierarchical graph comprising cognitive behavior modules and task modules relating to a mission, the cognitive behavior modules and the task modules being broken down into behavior modules, the behavior modules being broken down into action modules, the actions being elementary actions that can be observed by the artificial operator, the graph comprising an output level corresponding to a selection of elementary actions.

In one embodiment, the mission breakdown step involves using the information on the hierarchical graph originating from the current situation and from the parameters of human influence factors generated by the updated cognitive state.

In one embodiment, the parameters of human influence factors are used on multiple levels of the hierarchical graph.

In one embodiment, the parameters of human influence factors are used on a first level of the graph in order to determine cognitive behaviors, on a second level of the graph in order to determine behaviors and actions, and on a third level of the graph in order to determine a selection of actions.

The invention also relates to a computer program product comprising code instructions for carrying out the steps of the claimed method, when the program is executed on a computer.

In addition, according to the independent device claim, the invention relates to a device for generating the behavior of an artificial operator interacting with a complex system during a mission.

The device of the invention also comprises other means for implementing the steps of the method of the invention.

The use of the claimed device is the use in the aeronauticoeld for generating the behavior of an artificial pilot for piloting an aircraft in a flight simulation or for piloting a drone in the real world.

The invention also relates, according to the corresponding independent claim, to a method for building human behavior models. The human behavior model allows the behavior of an operator to be modeled both cognitively and procedurally.

The method for obtaining the human behavior model is based on an “Operator Behavior Knowledge Database” (BCCO) and on two distinct models, a cognitive model and a procedural model.

The BCCO allows a set of data to be recorded and capitalized, which set is gathered during sessions involving operators interacting with complex systems (data characterizing the observing, handling and communicating actions of the operator, physiological data relating to this operator and contextual data describing the state and dynamics of the complex system, the environment and the context of the mission, which is supplemented by subjective data concerning the behavior of the operator).

One method allows different categories of cognitive models (such as, for example, a mental load model) to be built based on the data recorded in the BCCO, using artificial intelligence techniques for machine learning. A person skilled in the art will apply the same principles to building any other cognitive model corresponding to other aspects of the cognitive state of the operators interacting with a given complex system. These models will be extended in order to be able to automatically simulate the evolution of the cognitive state of the operator.

Another method allows behavior models for constructive simulation, called “Constructive Models”, which are also referred to as “procedural models”, to be built based on the data recorded in the BCCO, using different artificial intelligence techniques combining machine learning and trade expertise.

The solution involves a modeling method that allows a database of human behavior models of the operators to be built and allows a behavior generation device to be produced that relies on this database for generating the behavior of artificial operators.

The human behavior models of the operators are built by combining cognitive models and procedural models. Each human behavior model corresponds to a given operator (or a class of operators) on a given complex system.

The method for building this new model category implements:
a behavior model format capable of combining the two categories of models that are involved;
trade expertise in order to define the structure of the model and identify which levels of the tree of the constructive model can be integrated with the links with the “human factors” (FH) generated by the cognitive models;
progressive improvement of the human behavior models of the operator by learning techniques again using the BCCO data as a reference.

The behavior generation engine allows the actions of an artificial operator interacting with a complex system in a simulation or with a real complex system to be selected, by:
initializing the generation engine with the human behavior model best corresponding to this operator, to the modeled complex system and to the mission or task that they must perform;
using the learned cognitive models to simulate the evolution of the cognitive state of the represented operator;
activating the generation engine based on the data originating both from the simulated cognitive state and from the current situation (context data+situation perceived by the artificial operator), to allow them to select the actions of the artificial operator.

The advantages of the device of the invention involve combining, in the behavior model used for generating behavior, both the objective data corresponding to the operating procedures of the complex system, and the subjective data corresponding to the cognitive state of the represented operator.

In this way, the behavior that is generated can strictly follow precise and regulated procedures when the situation is nominal, as would be the case for artificial agents in a conventional simulation. However, instead of using specific rules to take into account exceptional situations, the simulation of the cognitive state of the artificial operator allows behaviors to be triggered that are more representative of the actions of an actual operator in this type of situation.

More generally, integrating human factors into the decision-making of the artificial operator allows procedural behaviors to be selected that take into account the cognitive state of the represented operator and, conversely, allows cognitive behaviors that take into account the progress of the task or of the current mission to be generated.

It can be seen that the quality of the behavior generation clearly depends on the quality of the database of human behavior models of the operators, which itself depends on the amount of data that will have been able to be gathered in the BCCO.

With the development of high-quality human behavior models, validated by expert users of the complex system, the behavior generation engine that is proposed must allow what could be referred to as a “digital twin” to be modeled of a real operator allowing the real complex system they are interacting with to be controlled.

The aim of the invention is to generate an artificial behavior that is as close as possible to that of real operators, by building a digital twin of a real operator, or of a class of real operators, but that is limited to generating behavior.

### BRIEF DESCRIPTION OF THE DRAWINGS

Further features, details and advantages of the invention will become apparent from reading the description, which is provided with reference to the appended drawings, which are provided by way of an example and which respectively represent:

FIG. 1 schematically illustrates, for the example of a pilot, the phase of modeling cognitive models and the phase of executing models for evaluating the cognitive state of a pilot;

FIG. 2 schematically illustrates the phase of modeling procedural models and the phase of executing models for generating the behavior of a virtual pilot in a constructive simulation;

FIG. 3 illustrates the steps of building a human behavior model according to the invention, for the example of a pilot;

FIG. 4 schematically illustrates an environment for implementing the method for generating the behavior of an artificial operator of the invention;

FIG. 5 illustrates a sequence of steps of the method of the invention for generating the behavior of an artificial operator;

FIG. 6 illustrates an example of the implementation of the underlying structure of the human behavior model of the invention; and

FIG. 7 illustrates an example of generating the behavior of an artificial aircraft pilot, based on the hierarchical structure of FIG. 6.

### DETAILED DESCRIPTION

Although the invention is described for a preferred embodiment in the field of avionics, in order to generate the behavior of an artificial operator interacting with a (real or simulation) system, a person skilled in the art will be able to transfer the principles described to other fields.

Furthermore, the description provides the following definitions for the terms listed below:
Artificial operator: device/component representing an individual, a subject, a real person, i.e., a human being, which, within the context of the invention, is interacting (i.e., for piloting, controlling, activating, operating, acting on) with a complex system. For the described embodiment, the operator (artificial or real) is a pilot, and either term can be used without distinction;
Complex system: system comprising numerous devices that an operator (artificial or real) must interact with, and which can mobilize real operator involvement to a greater or lesser extent in terms of their handling time as well as their mental load. For the described embodiment, the complex system is an aircraft cockpit.

Before describing the invention, the following notes are provided in order to properly understand the invention.

### Note on Modeling the Behavior of Artificial Agents:

The behavior models are used by the constructive simulations and by the video games to animate the behavior of the participants not played by the trained participant, the player or, more generally, the operator of this type of application. These models allow the behavior of artificial participants to be generated who will perform tasks or missions within the context of a predefined scenario.

In almost all constructive simulations or games, the behavior models are procedural, i.e., the generated behavior corresponds to a sequence of prerecorded actions, generally organized in the form of a graph or by a set of “Conditions→Actions” rules that activate as a function of the perceptions of the participant in their environment.

The behavior procedural models are generally hand developed by an expert in the field (a “game designer” for games) in a procedural form (graph, tree structure, etc.) in order to model the various possible sequences of the progress of a mission.

These procedural models are generally built beforehand by the modeler in order to be used when executing the simulation or the game; however, due to their simplicity, they also can be built or modified during the course of this simulation or this game.

### Note on Modeling Human Behavior:

The concept of modeling human behavior (MCH) emerged in the field of simulation in the 1990s based on the idea that it was not possible to avoid the need for modeling human factors in order to configure how automated systems should make their behavioral choices, and thus avoid the bias of confronting a virtual enemy exhibiting robotic behavior that is easy to predict and that often can be deceived.

Unlike the behavior that can be generated by procedural automated systems, human behavior is characterized by involving the cognitive state in the decision-making. In this way, the behavior of a human being is not only much richer than that of any automated system, but it is also much less predictable since an external observer generally does not have access to the cognitive state of the observed individual, unless it is possible to deduce some of this hidden state by the expression on their face, by their posture or by any other indicator of their physiological state.

A large number of works exist in the academic field that have attempted to model various aspects of the cognitive state of a human being in order to generate the behavior of an artificial human. Without being exhaustive, these various models, listed hereafter, can be differentiated according to their original field:
psychological models are based on the psychology studies for representing various cognitive functions, such as, for example, beliefs, desires and intents, as is the case for the BDI (Believe, Desire, Intent) model by Michael Bratman;
psychophysiological models are models derived from the confluence of psychology and physiology studies that allow a link to be established between the cognitive state of an individual and their observable physical manifestations. The emotions model by Nico Frijda is a good example thereof;
biomimetic models are the models that biologists use to reproduce behaviors observed in a living being by simulation (this is the case, for example, of the motivations model by the ethologist David McFarland) or that computer specialists use in order to create artificial intelligence algorithms inspired by a living being (this is the case, for example, of the motivations model by Toby Tyrrell).

In the field of constructive simulation, it has been demonstrated that human factors (FH) could be used, which factors correspond to the various psychological and physiological parameters characterizing an actual person to be simulated, in order to influence the decision-making of the artificial participants.

Human factors can occur on three levels in the decision-making process:
a first level (FH1) where the human factors can trigger a new behavior, for example, in order to satisfy a motivation or to respond to a certain emotion;
a second level (FH2) where the human factors can influence the choice between several ways of performing a given behavior;
a third level (FH3) where the human factors can influence the efficiency with which selected actions will be performed.

### Note on the Analysis of Human Factors:

Modeling human factors in the simulations generally relies on experts building formal models, but a field exists where cognitive models of this type are the result of learning, namely the analysis of human factors.

Analysis of human factors is based on the production and use of cognitive models aimed at evaluating, for each of these models, an aspect of the cognitive state of the observed person.

The use of cognitive models (such as, for example, vigilance or mental load) allows various aspects of the cognitive state of the monitored operator to be evaluated. For example, a cognitive model for evaluating the mental load of a helicopter pilot within the context of a mission carried out in a simulator was carried out based on data gathered during several exercises involving the simulator and the pilot being instrumented.

Other cognitive models capable of evaluating other aspects of the state of a pilot (vigilance, drowsiness, inability, etc.) or for other fields of application (air traffic controller, nuclear power plant operator, etc.) can be contemplated.

With further reference to the present invention, it includes a modeling method that allows a database of human behavior models to be built and it relates to a device for generating the behavior of an artificial operator that is based on this database.

The human behavior models are built according to a method that combines cognitive models and procedural behavior models. Each human behavior model corresponds to a given operator and/or to a class of operators, for a given complex system.

The method for building this new human behavior model implements:
a behavior model format that combines the two categories of models that are involved (cognitive and procedural);
trade expertise for identifying which levels of the tree structure of the procedural model of the links with the “human factors” (FH) generated by the cognitive models (according to the three levels of influence of the FH described above) can be integrated;
progressive improvement of the human behavior models of the operator by machine learning techniques using the data from the operator behavior knowledge database (BCCO) as a reference.

The various phases that allow the models to be created that are required for operating the engine for generating the behavior of an artificial operator interacting with a complex system will now be described. They comprise:
(A) a phase of forming an “Operator Behavior Knowledge Database” (BCCO), which can be a “Pilot Behavior Knowledge Database” (BCCP) within the context of the description of a preferred embodiment;
(B) a phase of building cognitive models;
(C) a phase of building procedural models; and
(D) a phase of building human behavior models.

### (A) Forming an “Operator Behavior Knowledge Database” (BCCO)

Forming an Operator Behavior Knowledge Database (BCCO) allows use cases concerning the observation of the behavior of operators and corresponding data to be available that are required for building the models used to generate the behavior of an artificial operator interacting with a given complex system.

The BCCO initially can be produced from data derived from tests on instrumented simulators of the complex system, which facilitates both the gathering and the subsequent backup of the data. For example, cognitive models of pilots have been built based on data gathered from civilian aircraft simulators.

Data can be gathered directly on real systems (for example, on a civil aircraft during a flight).

The Operator Behavior Knowledge Database is enriched and completed over time in order to be able to refine the models and, in particular, those that are used for generating the behavior of an artificial operator.

The BCCO includes different types of data synchronously recorded by suitable sensors, namely:
data relating to the actions of the operator:
   observation actions (what is seen by the operator);
   handling, command actions (actions performed by the operator when using the instruments of the system);
   communication actions (what the operator vocally transmits when using the system);
physiological data (recorded on the operator from biometric sensors);
contextual data consolidating:
   the state and the dynamics of the complex system (for example, the avionics data if the operator is an airplane pilot);
   environment data of the system (for example, the weather or the position of other aircraft if the operator is an airplane pilot);
   data relating to the context of the mission (for example, the flight plan or the exercise scenario if the operator is an airplane pilot);
   optionally subjective data concerning the behavior of the operator.

In one embodiment, processing of the inter/intra personal and inter/intra operational variability can be applied to the data in order to consolidate them, and in order to allow more generic models to be built (i.e., not linked to a single operator).

For example, in the case of pilots:
it is possible to consolidate pilot data deemed to be close enough in terms of training, age, path, etc., to build models for classes of pilots;
it is possible to consolidate data concerning different pilots but that fly the same aircraft class and similar paths to build models for classes of missions.

A person skilled in the art thus understands that the quality of the generated behavior depends on the quality of the database of the models of the human behavior of the operators that, in itself, depends on the amount of data that will have been able to be gathered in the BCCO.

### (B) Building Cognitive Models

The “Cognitive Behavior Models” or “Cognitive Models” are used for analyzing human factors.

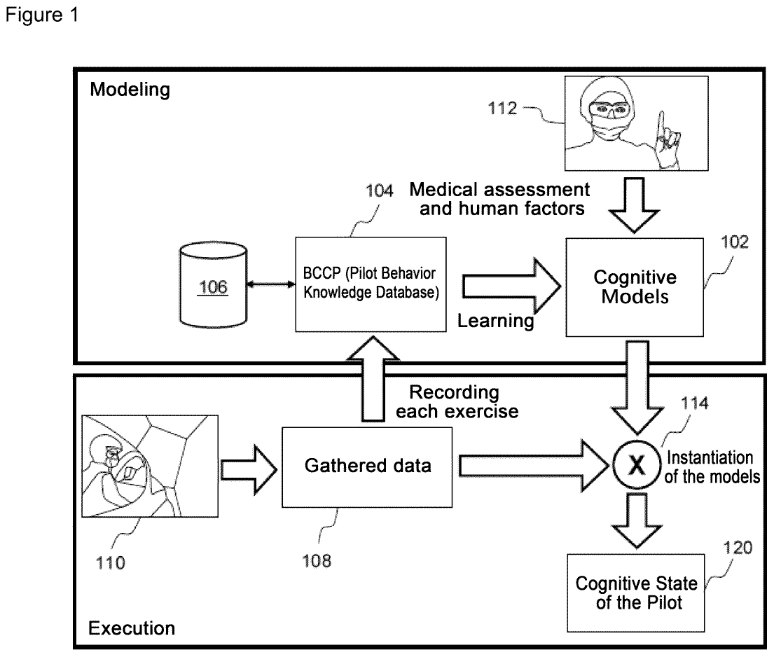

FIG. 1 schematically illustrates, for the example of a pilot, how the cognitive models (102) are developed (Modeling Phase) and how these models are used (Execution Phase) to evaluate (120) the cognitive state of a pilot, using the data from a “Pilot Behavior Knowledge Database” (BCCP) (104) consolidating, over many operational or simulated flight sessions, recorded data (106) concerning the behavior of the pilot: pilot actions (actions observing the outside of the cockpit and instruments, actions handling the controls and instruments of the aircraft, communication actions); physiological parameters recorded by biometric sensors; contextual information concerning the state and dynamics of the complex system (the airplane), the environment (weather, other participants/tactics/traffic, etc.), the mission of the pilot (flight plan and phases, for example) or more subjective information concerning their behavior (observation, declaration, annotation, qualification, etc.).

The cognitive models are developed using artificial intelligence techniques for learning, based on data (108) gathered over several exercises where the complex system and the operator are instrumented (110), for example, in an airplane simulator instrumented for this purpose. Exercises corresponding to realistic and productive scenarios with operational and cognitive variations are performed. The gathered data that consolidates objective data (sensor measurements; simulator probe; scenario) and subjective data (self-assessment; external expertise) are synchronized, and made available to the Pilot Behavior Knowledge Database (104), or more generally to the Operator Behavior Knowledge Database.

It should be noted that learning never occurs blindly and, most often, experts (112) are involved in order to define the intended type of model to be built by selecting the parameters to be used, for example.

The prior formation of a Pilot Behavior Knowledge Database (BCCP), or more generally of an Operator Behavior Knowledge Database (BCCO), containing synchronized recordings of interaction sessions with the complex system that is used, is thus a prerequisite for building cognitive models, whether this is to evaluate the mental load of an operator or other aspects of the state of an operator, i.e., their vigilance, their drowsiness, their incapacity, etc.

As illustrated in FIG. 1, in the execution phase, the gathered data are entries for an execution engine (114) that instantiates the appropriate cognitive model (102) in order to deliver information (120) representing the cognitive state of the pilot/operator.

### (C) Building Procedural Models

The “constructive behavior models” or “procedural models” are used by the constructive simulations to generate the behavior of each participant (not played) by the trained participant or by the instructor, and to allow this participant to complete their mission as a function of the situation they perceive.

In almost all constructive simulations, the behavior models are procedural, i.e., the generated behavior corresponds to a sequence of prerecorded actions, generally organized in the form of a graph or by a set of “Conditions→Actions” rules that activate as a function of the perceptions of the participant in their environment.

The procedural models are generally hand-developed by an expert in a procedural form (with a graphical representation, tree structure, etc.) in order to model the various possible sequences of the progress of a mission. These procedural models can be built live by the trained participant or by the instructor during the exercise, or they can be built by a modeler and recorded in a database in order to be reused throughout the course of the exercise.

Techniques exist for building procedural models that are partly the result of machine learning and where the expert is involved beforehand for, for example:
structuring the organization of the behaviors (for example: genetic learning of collective missions);
simplifying the input data (for example: behavioral tree learning);
defining the tests to be recorded (for example: case learning).

The use of learning is especially useful when it is difficult, or when this would take too much time, to build a procedural behavior model that addresses all the encountered situations. As soon as the problem becomes too complex in terms of the number of possible situations, a more generic model needs to be built using machine learning.

However, as in the case of learning cognitive models, the computation time of a procedural model of complete behavior quickly becomes prohibitive without the assistance of an expert in the studied system for identifying the parameters to be optimized or for defining the structure of the model in advance.

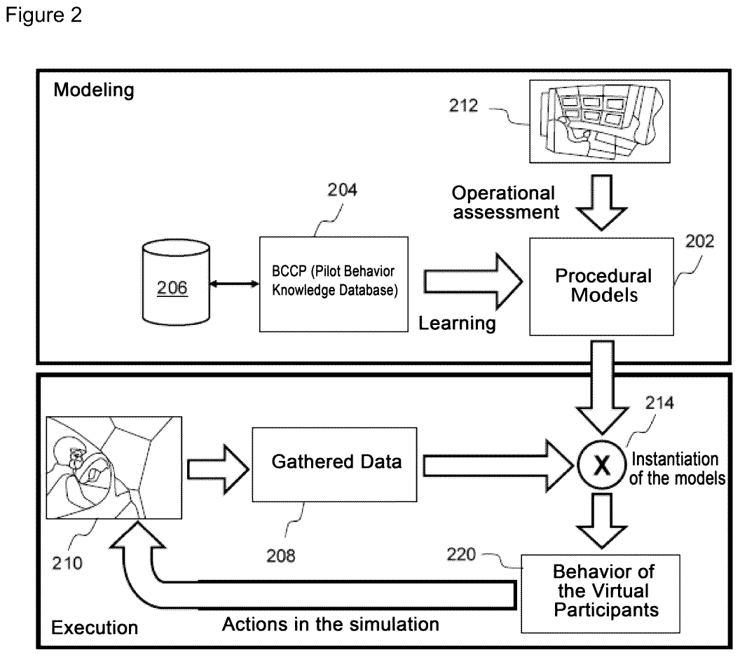

FIG. 2 schematically illustrates how the procedural models (202) are developed (Modeling Phase) and how these models are used (Execution Phase) to generate (220) the behavior of artificial participants in a constructive simulation.

The modeling phase allows procedural models to be built using, as a reference for learning a more general behavior than that proposed by operational experts (212), the data recorded in a “Pilot Behavior Knowledge Database” (BCCP) (204) consolidating, over many operational or simulated flight sessions, recorded data (206) concerning the behavior of the pilot: pilot actions (actions observing the outside of the cockpit and instruments, actions handling the controls and instruments of the aircraft, communication actions); physiological parameters recorded by biometric sensors; contextual information concerning the state and dynamics of the complex system (the airplane), the environment (weather, other participants/tactics/traffic, etc.), the mission of the pilot (flight plan and phases, for example) or more subjective information concerning their behavior (observation, declaration, annotation, qualification, etc.).

During the execution phase, the procedural models (202) are instantiated in the behavior engine of a constructive simulation (214) with the data from a simulation (208, 210) in order to generate (220) information representing the behavior of the artificial pilot.

### (D) Building Human Behavior Models

The human behavior models developed by the inventors are models that enhance the procedural models of parameters originating from modeling the cognitive state of the operator and the evolution of this cognitive state as a function of the evolution of the perceived situation, by contextual data and by actions performed thus far by the operator.

Advantageously, the models of the two categories of known models (procedural; cognitive) are combined into a single modeling structure.

Learning new human behavior models is based on each of these two categories by integrating both procedural components and cognitive components of the decision-making.

As explained above, a procedural model can be built that has evolved enough so as to be able to generate the behavior of an operator interacting with a complex system, provided that this operator follows the operating procedures of this system to the letter.

However, this latter condition is not always fulfilled since human operators may not follow the procedures to the letter, taking into account hidden factors that are difficult to evaluate from outside.

Even if it is difficult to reproduce the decision-making autonomy of a human operator, in any case in delicate or unplanned situations, it is possible to increase the efficiency of a behavior generation system by attempting to evaluate and then to model the intrinsic factors that can be involved in their decision-making.

These intrinsic factors in particular can be the aforementioned human factors (FH), for which some existing models allow, for example, the instructors to facilitate the evaluation of their pilot students.

However, it is clearly not possible to evaluate all the intrinsic factors that will divert the operator from the procedures, but only those that relate to their role as an operator. Thus, for a pilot, it will be possible to evaluate their vigilance, their consideration of the situation, their stress or their mental load, for example. However, other undetectable factors could occur in order to cause the pilot to make other behavioral choices.

This complex problem has led the inventors to seek to “enhance” the procedural models with additional parameters originating from the evaluation of the cognitive state of the operator.

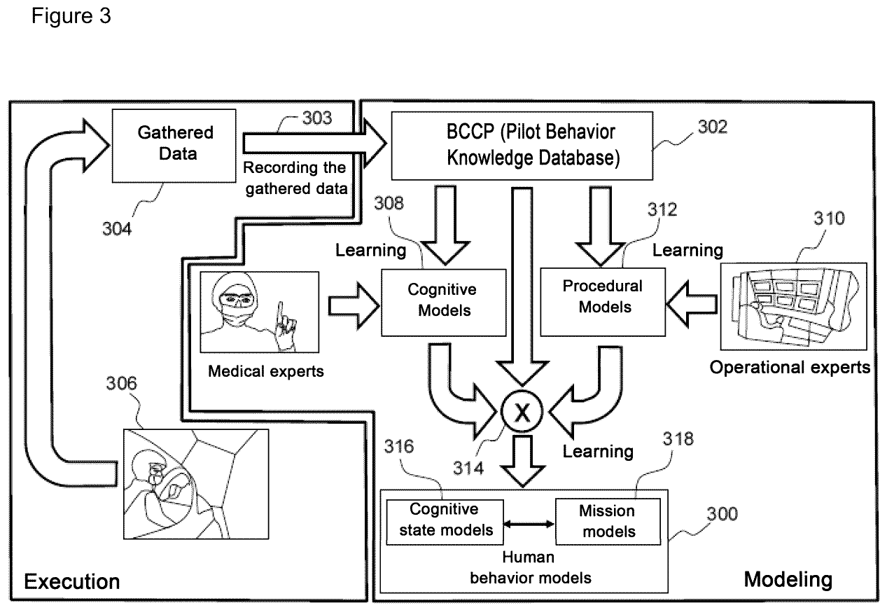

FIG. 3 schematically and concisely illustrates the process of building a human behavior model (300) according to the invention, using a pilot as an example.

The first step involves building a pilot behavior knowledge database BCCP (302) (or, more generally, an operator behavior knowledge database BCCO of a relevant application). As described above, the database is built with data (304) gathered when executing numerous exercises involving different pilots (or operators of the relevant application), interacting with a complex system (306) (in this case, pilots in their aircraft). The gathered data characterize observing, handling and communicating actions of the operator, physiological data relating to the operator and contextual data consolidating data concerning the state and dynamics of the complex system, environment data, and data relating to the context of the mission, and, optionally, subjective data concerning the behavior of the operator. These gathered data can be used in a second phase by the behavior generation engine.

During the modeling phase, the Pilot Behavior Knowledge Database (302) is used to build a cognitive model database (308) with assistance from medical experts and using machine learning algorithms.

At the same time, during the BCCP modeling phase, modelers (310) assisted by operational experts (in this case, experienced pilots) define and build the structure of the procedural models (312), which are then adapted by learning techniques using the data from the BCCP (302) to form databases of procedural models that are specific to each operator or to each category of operators.

Still in the modeling phase, the gathered exercise data that are synchronized (304) and recorded in the Pilot Behavior Knowledge Database will allow learning (314) to be carried out, in combination with the cognitive models and the procedural models, in order to build:
cognitive state models (316) allowing the evolution of the parameters of human influence factors to be modeled as a function of the context represented by the operator and the task they are carrying out using the complex system (for example, the pilot completing their mission); and
task/mission models (318) incorporating parameters of human influence factors originating from cognitive state models (316) into their operating rules, with the human factors being taken into account according to three levels of influence (the three types of connections FH1, FH2, FH3 described in the previous section).

Combining the two categories of models, namely the cognitive state models and the mission models, taking into account the parameters of human influence factors, forms the human behavior models (300) (pilot or more generally operator).

The data recorded in the BCCO are therefore used to characterize the behavior choices of the operators by building different human behavior models for each individual operator (or for categories of operators with similar behavior).

The human behavior model that is learned and instantiated for an operator is used, in the operating mode, to initialize a behavior generation engine that, based on the input data characterizing the current situation of the artificial operator, is capable of outputting a behavior and actions similar to the behavior and actions that a real operator would perform in this situation.

It can be seen that the technical difficulties and barriers of the proposed approach relate to:
the formation of an operator behavior knowledge database BCCO (302) of the relevant application (BCCP for pilots) that is rich enough to complete all the learning;
the formation of a cognitive state model database (316), with sufficient parameters for describing the influences of the state of an operator (for example, a pilot) on their behavior choices;
the possibility of learning the evolution models of the various parameters characterizing the cognitive state of the operator (for example, of the pilot) as a function of their personal characteristics, their perceptions and their actions;
the possibility of learning, based on the data of the BCCO (for example, of the BCCP), the relevant and differentiated procedural models (312) according to the operators (for example, pilots) or categories of operators (for example, categories of pilots);
the ability to link the data originating from the cognitive state models and the procedural models by machine learning in order to reproduce the behaviors of the operators (for example, pilots) recorded in the BCCO (for example, the BCCP).

The latter point is the most difficult to process since, while it is possible to assume that the behavior choices of an operator interacting with a complex system (for example, a pilot in their aircraft) depend both on their perception of their environment and their cognitive state, it is more difficult to ensure that all the perceptions relevant to the operator will be taken into account in the model and, more importantly, that the measurements captured on the operator will be sufficient to determine all the intrinsic factors that occur when selecting the actions of the operator.

The formation of human behavior models, as described above, allows these models to be integrated in a constructive simulation of the artificial operators whose generated behavior is very close to that of real operators interacting with a complex system.

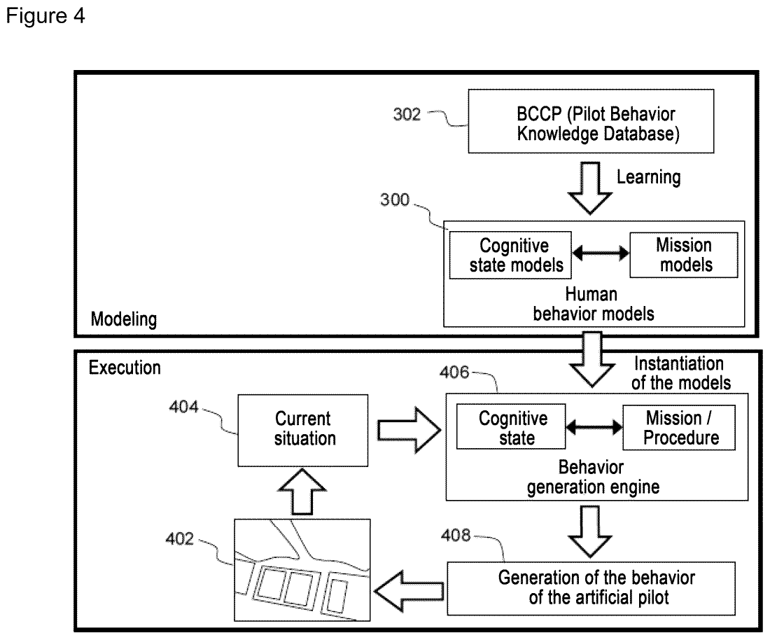

FIG. 4 schematically illustrates an environment for executing the method of the invention. The example is illustrated for an aeronautical environment with a view to applying the method for generating the behavior of an artificial operator to an artificial pilot. However, a person skilled in the art can apply the described principles to any other environment as mentioned above, such as to industry and rail or road transport, the fields of safety, process control, etc., and for any artificial operator.

The method of the invention allows, for the described example, the behavior to be generated for an artificial pilot (408) behaving like the pilot or the class of pilots used as a model, and does so, not by optimally applying the flight procedures, but by exhibiting a behavior representing the behavior of a real pilot.

A direct use involves being able to reproduce the behavior of real pilots in a simulation so as to increase the realism of this simulation, which can be worthwhile both for training needs and for the purposes of studies.

Ultimately, subject to the validation of these human behavior models, it seems possible to be able to replace an actual operator interacting with a real complex system with what could be referred to as a “behavioral digital twin”. A practical application for aeronautics would be piloting a drone aircraft by an artificial pilot behaving in a similar manner to a real pilot whose data would have been recorded in the BCCP. The aim is not to impart a drone with behavior that could be qualified as optimal, but to impart it with behavior that is as close as possible to that of a human, and that is therefore easier to understand from the perspective of human-machine relationships. Extensions to the application of the invention can involve the formation of robotic wings or of a fleet of drones that would help the pilots of next-generation fighter aircraft to complete their missions.

Even if a lot of information cannot, by definition, be accessible, the data recorded in the BCCO can be used to characterize the choices of behavior of the operators (or, in the BCCP, for pilots), by building different human behavior models for each individual operator (or for operator categories with similar behavior). These human behavior models feed a behavior generation engine that will be able to instantiate them in order to simulate the cognitive state of the artificial operator, to manage the progress of their missions and to modulate their choices of action as a function of the human factors associated with this simulated cognitive state.

The device for generating the behavior of an artificial operator, illustrated in FIG. 4, is applied to the example of an artificial pilot in the cockpit of a simulated airplane (402) whose behavior is to be generated in a constructive simulation.

By definition, generating the behavior of an artificial participant in a constructive simulation operates in a closed loop with the rest of the simulation. For each time step, the artificial participant (i.e., the hardware/software component) receives an update from the simulation module concerning the current situation that will allow it to make decisions and to select the actions of the participants under its control; these actions in turn affect the evolution of the situation for the next time step.

The implementation of the device for generating the behavior of an artificial operator is broken down as follows:
the human behavior models (300), the results of the learning described above, are instantiated in a behavior generation engine (406) using the personal data of the represented operator (in this case a pilot) and the mission conferred to them;
for each time step, the generation engine (406) will update the cognitive state of the artificial operator as a function of its current situation (404). The current situation comprises:
(a) The perceived situation, which for a pilot corresponds, for example, to:
   what they see on their instruments;
   what they see outside their cockpit;
   what they hear in their cockpit or through their communication instruments.
(b) The context data, which for a pilot corresponds, for example, to:
   the context of their mission (plan, trajectory, instructions, etc.);
   their knowledge of the complex system and of their current state;
   the elements they know from their environment (weather, presence of other participants, etc.).
Then, the engine breaks down the mission into a tree structure of tasks and behaviors using the information originating from the current situation and from human factors generated by its cognitive state;
At the end of the cycle, the behavior generation engine proposes new actions for the artificial operator that will not only influence the state of the complex system with which the artificial operator is interacting, but will also influence the evolution of its cognitive state.

The context data can include information concerning the state of the complex system (i.e., information concerning states inherent to normal operation, such as, for example, a power percentage of the engines, if the fins are folded or unfolded, the state of the fuel tanks, etc., and the information concerning states inherent to abnormal operation, such as, for example, information indicating that the left engine has failed, the right pedal of the copilot seat is faulty, or any kind of potential fault). The context data can include flight data such as: the route, the altitude, the speed, the acceleration, the attitude and the envelope. Moreover, the parameters of the airplane can be taken into account, such as: the date of the last maintenance, any events occurring during a flight, etc.

The device of the invention comprises computing resources or a data processing module (406) configured to implement the engine for generating the behavior of an artificial participant with the gathered situation data.

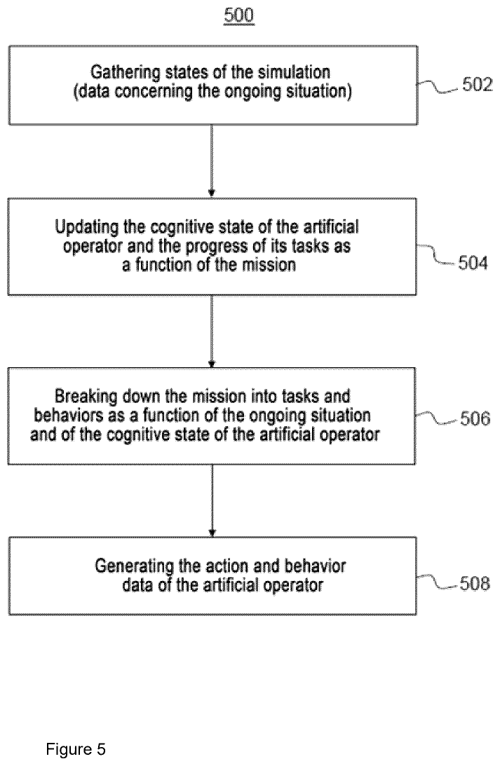

FIG. 5 illustrates a sequence of steps of the method of the invention for generating the behavior of an artificial operator interacting with a complex system. The method (500) is computer-implemented and comprises steps of:
(502): gathering states of the simulation, corresponding to data concerning the current situation (perceived situation, context data concerning the mission, the system and the environment);
(504): using the gathered data as entries for the behavior generation engine in order to update the cognitive state of the artificial operator and the progress of the tasks relative to the mission (i.e., according to the mission scenario that has been defined for the constructive simulation);
(506) based on the updates, breaking down the mission into new tasks and behaviors; and
(508) generating action and behavior data of the artificial operator.

The method implements a human behavior model (300) modeling the behavior of the represented operator, both cognitively and procedurally. The human behavior model that is instantiated for this operator has been learned during the learning phase (previously described), by applying artificial intelligence techniques to cognitive models and to procedural models, with data capitalized in a knowledge database of the behavior of operators of complex systems.

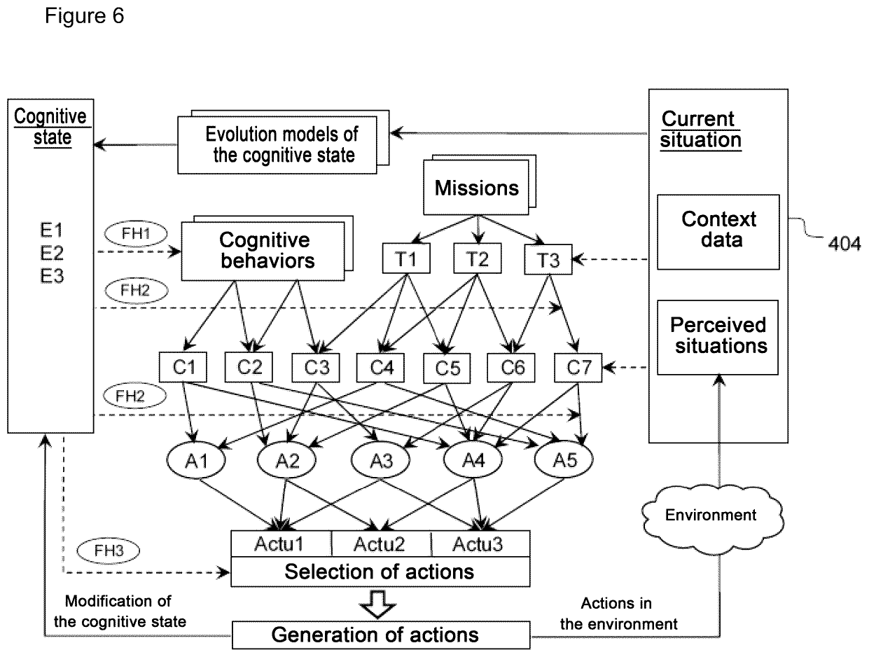

FIG. 6 illustrates an example of the implementation of the underlying structure of the human behavior model of the invention, which allows the behavior model of a represented operator to be instantiated via the behavior generation engine, with this behavior model for this operator having been obtained from the human behavior models built by learning using an operator behavior knowledge database (BCCO).

For the sake of the clarity of the description, by convention in FIG. 6 the left-hand side of the tree structure is considered to represent the structure associated with cognitive models, and the right-hand side of the tree structure is considered to represent the structure associated with procedural models.

The current cognitive state of the artificial operator is located on the far left. The components of this state (E1, E2 and E3) are elements of the state of the operator (such as stress or vigilance). This state is initialized and updated by virtue of the evolution models of the cognitive state that are built based on the cognitive models described above.

The current cognitive state of an artificial operator is evaluated based on various components Ei, which represent as many psychophysiological models characterizing the evolution of the cognitive state of this operator as a function of the evolution of the current situation and of the actions they perform. Thus, for example, components E1, E2 and E3 in FIG. 6 can represent, for an artificial pilot, an evaluation of their stress (E1) based on a cognitive model of stress evolution, an evaluation of their vigilance (E2) based on a cognitive model of vigilance evolution, an evaluation of their mental load (E3) based on a cognitive model of mental load evolution.

A cognitive behavior CCi of the operator can be triggered by a certain configuration of the state of the operator. This behavior corresponds to a first level influence of human factors (represented by the arrow FH1), i.e., a level where human factors can trigger a new behavior. Thus, for example, the evolution of the cognitive state of an artificial pilot exhibiting a very low vigilance level can generate a cognitive behavior involving the pilot sleeping.

However, a cognitive behavior is not necessarily elementary, and it can be broken down into a plurality of simpler behaviors Ci (for example, the behavior modules C1 to C3).

The behaviors Ci themselves each can be broken down into a plurality of observable elementary actions Ai of the operator (for example, the action modules A1 to A5).

The whole of this hierarchical structure (Ci; Ai) of the cognitive behavior model can be the result of machine learning, combined with an assessment of the cognitive models.

The right-hand side of the figure represents the structure associated with the constructive behavior models:
the evaluation of the current situation of the artificial operator is located on the far right and is made up of both context data and perceived data originating from the simulation environment. This perceived situation is recorded based on interfaces with the simulation, allowing what the operator sees, what they hear or know and what they feel to be simulated;
the operator has one or more missions. Each of these missions can be hierarchically broken down into a plurality of procedural tasks Tj (for example, the task modules T1, T2, T3), which themselves each can be broken down into behaviors (for example, the behavior modules C3 to C7);
the behaviors Cj themselves each can be broken down into a plurality of observable elementary actions Aj of the operator (for example, the action modules A1 to A5) that they can perform in order to complete the mission.

In the same way as for the cognitive behaviors, the hierarchical structure (Tj; Cj; Aj) of the procedural behaviors can be the result of machine learning, combined with the doctrinal knowledge of an operational expert.

Advantageously, the human behavior model of the invention establishes links between the cognitive behavior models and the procedural models (constructive behavior models), according to the hierarchical structure of the behavioral tree and of the mission tree. These links (illustrated in FIG. 6 by all the interconnections between the various hierarchical levels of the two categories of models), provide a representation of the behavior of an operator in all their components (cognitive and procedural).

A first interconnection level is the possibility of having behavior modules (Ci, Cj) that are common in the tree structure, with these behavior modules being able to be activated either by a cognitive behavior, or by a task of a mission, or by both simultaneously.

FIG. 6 shows that the behavior module C3 is a common behavior module. The behavior module C3 is derived from a cognitive behavior CCi and it is also derived from the breakdown of the task referenced in the task module T1. Thus, when implementing the human behavior model, behavior modules that are common to both models can be activated either by a cognitive behavior, or by a mission task, or by both simultaneously (and then a compromise behavior can be proposed).

A second interconnection level corresponds to the second level of influence of human factors (FH2), i.e., the level where the human factors can influence the choice between several ways of performing a given behavior. The principle involves using the cognitive state of the operator to influence the breakdown of the tasks Tj or the breakdown of the behaviors (Ci, Cj) of the mission tree. For example, a stress state of the artificial operator can increase the weight of a more cautious behavior in the behavioral tree.

A third interconnection level relates to triggering the actions. Indeed, the two behavioral hierarchies (cognitive; procedural) are necessarily competing at this level. Each action module (Ai, Aj) can be activated by a module of the cognitive tree, by a module of the mission tree or by both at the same time.

Advantageously, the parameters of human factors influencing the determination of behaviors and actions of the operator are used on several levels of the hierarchical graph.

In one embodiment, the parameters of human influence factors are used on a first level of the graph to determine cognitive behaviors, on a second level of the graph to determine behaviors and actions, and on a third level of the graph to determine the selection of the actions that must be generated.

FIG. 6 illustrates, for example, that the action module A1 is common to the behavior module C1 originating from the breakdown of a cognitive behavior and to the behavior module C4 originating from the breakdown of the task module (T1 and/or T2).

The last level of the tree structure is the action selection level (illustrated at the bottom of FIG. 6). This level operates according to the known actuator principle. Each action is represented by a combination of one or more actuators (Actu1, Actu2 and Actu3). This determines the possibility of excluding simultaneous actions, but also of performing several actions simultaneously. For example, a military pilot cannot look at their instruments and outside their cockpit at the same time. However, they can easily perform one of these two actions and pull the trigger on their gun at the same time.

At the end of the action selection process, the human behavior model of the invention involves, on this last level of the tree structure, the last level (FH3) of influence of human factors on behavior (illustrated by the arrow FH3 in FIG. 6), i.e., the level where human factors can influence the efficiency with which actions will be carried out.

Indeed, the cognitive state of the artificial operator can alter the efficiency of the actuators, thus limiting the performance of the selected actions. The cognitive state is then taken into account for selecting the actions. For example, shaking hands due to stress or the phenomenon of tunneling that limits the field of view can be modeled and taken into account when selecting the actions taken by the model.

The final result of this process is the generation of the behavior of the artificial operator and, in particular, of the new actions that this operator will perform in the simulation.

This generation of behavior can directly affect the cognitive state of the artificial operator. Thus, some actions may increase or decrease its stress. An excessively large number of activated behavior modules can also increase its workload, etc.

This generation of the behavior can also indirectly affect the future behavior of the artificial operator and its simulated cognitive state. Indeed, the actions that are carried out in the simulation environment and in particular on the complex system can lead to a modification thereof and therefore can modify the situation that the artificial operator will perceive.

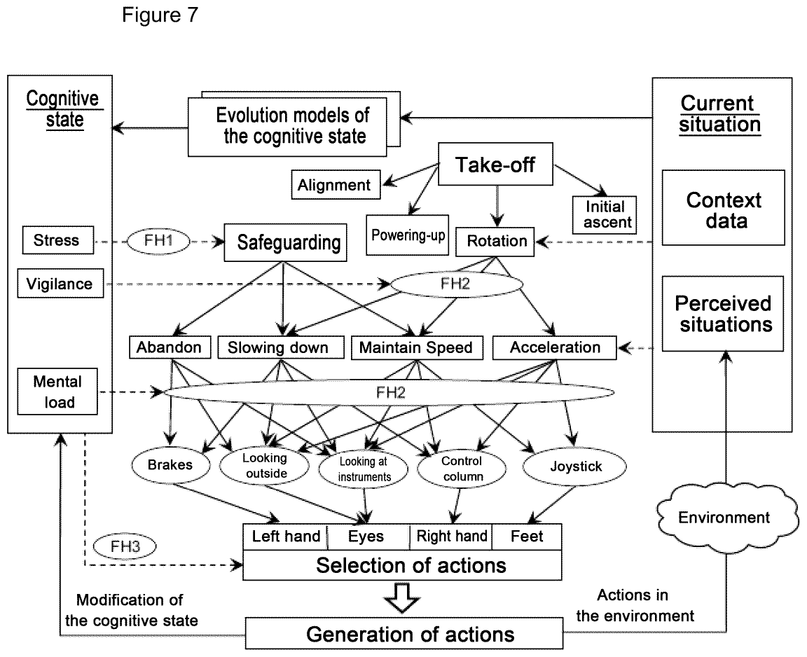

FIG. 7 illustrates an example of the operation of the engine for generating the behavior of an artificial operator with the generation of the behavior of a pilot in an aerial simulation, based on the hierarchical structure shown in FIG. 6.

In this example, which is deliberately simplified with respect to genuine human behavior models, it is assumed that sufficient interfaces are available with the aerial simulation in order to be able to build the situation that a real pilot would perceive. It is also assumed that it was possible to build models of the evolution of the cognitive state for simulating the stress, the vigilance and the mental load of this pilot during the take-off phase of their airplane.

The behavior generation engine will allow the procedures to be conducted that a real pilot should follow during the various steps of this flight phase, ranging from the alignment on the departure runway to the initial ascent.

In this exercise scenario, during the rotation phase, which is the phase that allows taxiing on the runway by increasing the power until the take-off speed is reached, an incident is introduced that involves a flock of birds crossing the runway, with this incident being a source of danger for the airplane and its occupants.

Building the human behavior model allows the behavior of different pilots in this situation to be simulated as a function of the characteristics that will affect the evolution of the various elements of their cognitive state:
an inexperienced pilot will experience an increase in their stress level, which can activate a “Safeguarding” behavior (human influence factor FH1) and result in them abandoning their take-off;
an unfocused pilot can exhibit a lack of vigilance on take-off that can cause them to continue their “Acceleration” as if nothing was wrong. The vigilance of the pilot can influence their procedural behavior for the current mission (human influence factor FH2);
however, an experienced and focused pilot will maintain a significant level of vigilance while keeping their stress level fairly low, which will probably prompt them to choose one of the following two behaviors “Slow Down” or “Maintain Speed” in order to allow the flock of birds to pass before resuming their take-off.

Irrespective of the behavior generated by the engine as a function of the perceived situation and of the state of the pilot, this behavior will be broken down into several elementary actions, which optionally can be simultaneous. These elementary actions also can be altered by a high level of mental load of the pilot (human influence factor FH2).

In the example of abandoning take-off, the elementary actions of the artificial pilot can be a braking action, an external monitoring action, an instrument monitoring action, for example.

The actual completion of the actions selected by the pilot involves the use of actuators (hands, feet, eyes), the effectiveness of which also can be reduced by an abnormal level of the state of the pilot (human influence factor FH3).

Irrespective of the situation of the aircraft and the cognitive state of the pilot, the learned human behavior model must allow the behavior generation engine to not only select the actions that will actually be performed by the artificial pilot in the simulation, but also must allow the generation of this behavior to be consistent with respect to the characteristics of the simulated pilot.

The present description illustrates a preferred implementation of the invention that is not limiting. Examples are selected to provide a proper understanding of the principles of the invention and a practical application, in particular to the field of avionics, but they are not exhaustive and must allow a person skilled in the art to apply modifications and alternative embodiments according to the fields of application, while maintaining the same principles.

The device and the method of the invention are advantageous for all systems involving modeling and simulation of the behavior of human operators interacting with a complex system.

Numerous industrial applications will discover advantages of implementing the device and the method of the invention, and they all relate to possible simulations involving an operator and a complex system where the two-fold requirement of operational and human realism is important.

The applications that can be contemplated notably are:
transport simulation in the broadest sense (aeronautical, railway, maritime, automobile, etc.) where the aim is accurate simulation of the behavior of an aircraft pilot, a train, boat or car driver, for example;
the situation management fields (air traffic control, public safety officer, etc.);
the process management fields (power generation, power plant operator, etc.).

The use of the invention can relate to:
the systems for training, practicing, studying or assisting with decision-making involving the accurate simulation of an artificial operator interacting with complex systems that are also simulated;
the partial or complete replacement of real operators with artificial operators capable of generating a behavior close to that of the real operators using a real system.

To summarize, the main elements of the present invention relate to:
a method for creating a database of human behavior models of operators interacting with a complex system, equally integrating cognitive elements (operator state), procedural elements (missions and procedures of the operator) and the various interactions between these two categories of elements. This database is formed by machine learning based on data recorded in a knowledge database of the behavior of operators during interaction sessions of a cohort of operators with the studied complex system;
a device (and its method) for generating the behavior of an artificial operator interacting with a complex system and, in particular, for simulating the evolution of its cognitive state, using the data originating from a simulation environment containing an evolved model of the complex system or a real environment containing the actual system. The device relies on the database of human behavior models of the operators that has been formed in order to produce evolved constructive models, benefiting from the modeling of the cognitive state of this operator.

In addition to these points, the present invention is a new way of understanding modeling of the behavior of an operator or of a class of operators by machine learning that is able to use both expert data procedurally characterizing the behavior of this operator or of this class of operators, and real data originating from recording, during the interaction situation, the behavior of this operator or of this class of operators with the studied complex system.

1. A method for generating the behavior of an artificial operator interacting with a complex system during a mission, the mission being a real or simulated mission, the method being computer-implemented and comprising the steps of:
gathering a plurality of data concerning the current situation of the complex system;
supplying the gathered data as input for a data processing module comprising a behavior generation engine instantiating a human behavior model in order to cognitively model the internal state of an operator and to procedurally model formalized or observed operating procedures for the complex system, said human behavior model being a single hybrid modeling structure built by learning from trade expertise and from interaction data of handling, observing and communicating between one or more real operators and the complex system, the data processing module operating with the gathered data by following steps of:
updating the cognitive state of the artificial operator, the cognitive state of the artificial operator being represented by a set of psychophysiological variables representing human factors that can influence the behavior and decision-making of real operators;
updating the progress of the tasks instantiated in the behavior generation engine, taking into account the new cognitive state of the artificial operator, in order to carry out the mission;
using based on the new cognitive state of the artificial operator and the progress of the tasks in the mission, the human factors modeled by the cognitive state of the simulated operator in order to influence a breakdown of the mission into a tree of new tasks ending with the generation of behavior and action data, this influence of the human factors being able to be exerted by generating new behaviors in the tree directly linked to the evolution of this cognitive state, by orienting the choices of behaviors or actions of the artificial operator during the breakdown of the mission and by modifying the effectiveness of the selected actions as a function of this new cognitive state.

2. The method as claimed in claim 1, wherein the hybrid human behavior model instantiated for the artificial operator has been learned in a learning phase, by applying artificial intelligence techniques to cognitive models and to procedural models using, over numerous simulations, a plurality of learning data for different operators, the learning data being capitalized in a knowledge database of the behavior of operators of complex systems.

3. The method as claimed in claim 1, wherein the step of updating the cognitive state of the artificial operator takes into account the current situation that includes data concerning the situation perceived by the artificial operator and mission and environment context data.

4. The method as claimed in claim 1, wherein the hybrid human behavior model is represented as a hierarchical graph comprising cognitive behavior modules and task modules relating to a mission, the cognitive behavior modules and the task modules being broken down into behavior modules, the behavior modules being broken down into action modules, the actions being elementary actions that can be observed by the artificial operator, the graph comprising an output level corresponding to a selection of elementary actions.

5. The method as claimed in claim 4, wherein the mission breakdown step involves using, on the hierarchical graph, information originating from the current situation and from the parameters of human influence factors generated by the updated cognitive state.

6. The method as claimed in claim 5, wherein the parameters of human influence factors are used on multiple levels of the hierarchical graph.

7. The method as claimed in claim 6, wherein the parameters of human influence factors are used on a first level of the graph in order to determine cognitive behaviors, on a second level of the graph in order to determine behaviors and actions, and on a third level of the graph in order to determine a selection of actions.

8. A device for generating the behavior of an artificial operator interacting with a complex system during a mission, the mission being a real or simulated mission, the device comprising means for implementing the steps of the method as claimed in claim 1.

9. The use of the device as claimed in claim 8 for generating the behavior of an artificial pilot interacting with a simulated aircraft or interacting with a real drone during a mission.

10. A computer program comprising code instructions for executing the steps of the method as claimed in claim 1, when said program is executed by a processor.

11. The method as claimed in claim 1, comprising preliminary steps of building human behavior models, said preliminary steps involving:
building an operator behavior knowledge database BCCO based on data derived from operators interacting with a complex system;
using the BCCO data to build a database of cognitive models by learning;
using the BCCO data to build a database of models specific to each operator or to each category of operators by learning;
using the BCCO data, the data from the database of cognitive models, and the data from the database of specific models, to build the following by learning:
cognitive state models allowing the evolution of parameters of human influence factors to be modeled, as a function of the context represented by the operator and the task they are carrying out when they are interacting with the complex system;
mission models incorporating the parameters of human influence factors originating from cognitive state models into their operating rules, with the
parameters being taken into account according to three levels of influence; the combination of cognitive state models and of mission models forming hybrid modeling structures representing human behavior models for an operator or a category of operators.

12. A device for generating the behavior of an artificial operator interacting with a complex system during a mission, the mission being a real or simulated mission, the device comprising means for implementing the steps of the method as claimed in claim 11.

13. The device as claimed in claim 12, wherein the means implement artificial intelligence techniques in order to perform machine learning.

14. A method for building human behavior models comprising steps of:
building an operator behavior knowledge database BCCO based on data derived from operators interacting with a complex system;
using the BCCO data to build a database of cognitive models by learning;
using the BCCO data to build a database of models specific to each operator or to each category of operator by learning;
using the BCCO data, the data from the database of cognitive models, and the data from the database of specific models, to build the following by learning:
cognitive state models allowing the evolution of parameters of human influence factors to be modeled, as a function of the context represented by the operator and the task they are carrying out when they are interacting with the complex system;
mission models incorporating the parameters of human influence factors originating from cognitive state models into their operating rules, with the parameters of human influence factors being taken into account according to three levels of influence;
the combination of cognitive state models and of mission models forming unique hybrid modeling structures, with a hybrid model being a human behavior model for an operator or a category of operators.
